(19) United States
(12) Patent Application Publication
(10) Pub. No.: US 2023/0284814 A1
(43) Pub. Date: Sep. 14, 2023

(54) CURTAIN CARRIER AND INSTALLING METHOD THEREOF

(71) Applicant: ARLINEA INDUSTRIES CO., Taoyuan City (TW)

(72) Inventor: Yu-Heng YU, Taoyuan City (TW)

(21) Appl. No.: 18/118,744

(22) Filed: Mar. 8, 2023

(30) Foreign Application Priority Data
Mar. 10, 2022 (TW) 111108805

(51) Int. Cl. A47H 1/18; A47H 1/13

(52) U.S. Cl. CPC A47H 1/18; A47H 1/13

(57) ABSTRACT

This disclosure is directed to a curtain carrier, having a frame (100), a hanging rod (200), a pressing block and an elastic member (400). The frame (100) is of an elongated shape, and the hanging rod (200) is accommodated in the frame (100). The pressing block (300) is arranged at one end of the frame (100), the pressing block (300) is disposed corresponding to one end of the hanging rod (200). The pressing block (300) is movable along a longitudinal direction of the hanging rod (200). The elastic member (400) is arranged on the frame (100) and compressible by the pressing block (300).

### BACKGROUND OF THE DISCLOSURE

### Technical Field

The technical field relates to a curtain, and more particularly relates to a curtain carrier that may be installed without screws.

### Description of Related Art

In related art, the curtain is installed by pre-installing a locking bracket in a window or on a wall above the window, and then installing a curtain hanging rod on the locking bracket. Such installation operation is not very convenient. Moreover, the locking bracket must be mounted onto the window or installed into a hole of the wall, which may affect the appearance or damage waterproofness of the structure. Particularly, a roller blind is usually rolled up and wound around the hanging rod, and the overall weight becomes heavy, which makes the installation operation even more inconvenient.

In view of the aforementioned problem, the inventor proposed this disclosure based on his expert knowledge and elaborated researches to overcome the problem of the related art.

### SUMMARY OF THE DISCLOSURE

This disclosure provides a curtain carrier curtain carrier that may be installed without screws.

This disclosure provides a curtain carrier including a frame, a hanging rod, a pressing block, and an elastic member. The frame is of an elongated shape, and the hanging rod is accommodated in the frame. The pressing block is arranged at one end of the frame corresponding to one end of the hanging rod, and the pressing block is movable along a longitudinal direction of the hanging rod hanging rod. The elastic member is arranged on the frame and compressible by the pressing block.

In the curtain carrier of this disclosure, the frame includes a stop pin, the elastic member includes a propping block with a slope, and the stop pin abuts against the slope. The stop pin is screwed to the frame and perpendicular to the hanging rod.

In the curtain carrier of this disclosure, the hanging rod is disposed pivotally to the frame and rotatable with respect to the axial direction of hanging rod as the axis of rotation.

In the curtain carrier of this disclosure, the pressing block includes a sliding pin, an inner side of the frame is provided with a guide rail, the guide rail is extended in a direction parallel to the hanging rod, and the sliding pin is movably plugged and connected to the guide rail to guide the pressing block. The hanging rod includes a hanger, the hanger has a sliding groove extended in a direction parallel to the hanging rod, the hanging rod is pivotally connected to the hanger, the sliding pin includes a hook passing through the sliding groove for the hanger to be hung on the sliding pin. The sliding pin includes a compression screw for pressing an inner wall of the guide rail to fix the pressing block.

In the curtain carrier of this disclosure, an outer side of the pressing block is attached with an elastic layer which is made of polyurethane, silicone, or rubber.

This disclosure is also directed to a installing method of a curtain carrier, the method including: providing a curtain carrier, wherein the curtain carrier includes a frame, a hanging rod, a pressing block and an elastic member, the hanging rod is accommodated in the frame, the pressing block is arranged on the frame, one end of the pressing block is arranged corresponding to the hanging rod, the pressing block is movable along a longitudinal direction of the hanging rod, and the elastic member is arranged on the frame and compressible by the pressing block; withdrawing pressing block toward the frame to compress the elastic member, and fixing the pressing block; placing the curtain carrier into a window, and setting the pressing block and one side of the frame opposite to the pressing block to face two side edges of the window respectively; releasing the pressing block to restore the elastic member to the original position and abutting the pressing block and the frame against the two side edges of the window respectively by the elastic force of the elastic member.

In the installing method of this disclosure, the frame includes a stop pin screwed to the frame, one end of the elastic member is provided with a propping block, and the propping block has a slope, and the stop pin abuts against the slope, and the installing method further includes: twisting the stop pin to change the position of the stop pin abutting against the slope to change the position of the propping block parallel to the hanging rod, so as to change the compression amount of the elastic member.

The curtain carrier of this disclosure may change the overall length of the curtain carrier through the movable pressing block to facilitate installing the curtain carrier in the window, and fixing the curtain carrier by applying force to the pressing block through the elastic member. Therefore, the curtain carrier of this disclosure may be installed without the need of using any screw to be locked on the wall structure to achieve an easy installation. In addition, the hanging rod and the drape may be stored in the frame to avoid exposure.

### BRIEF DESCRIPTION OF THE DRAWINGS

FIG. 1 is a perspective view of a curtain carrier in accordance with one embodiment of this disclosure;

FIG. 2 is an exploded view of a curtain carrier in accordance with one embodiment of this disclosure;

FIG. 3 is a longitudinal sectional view of a curtain carrier in accordance with one embodiment of this disclosure;

FIG. 4 is a cross-sectional view of a curtain carrier in accordance with one embodiment of this disclosure;

FIG. 5 is a schematic view showing a using status of a curtain carrier in accordance with one embodiment of this disclosure; and

FIG. 6 is a flow chart of a curtain carrier installing method in accordance with one embodiment of this disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

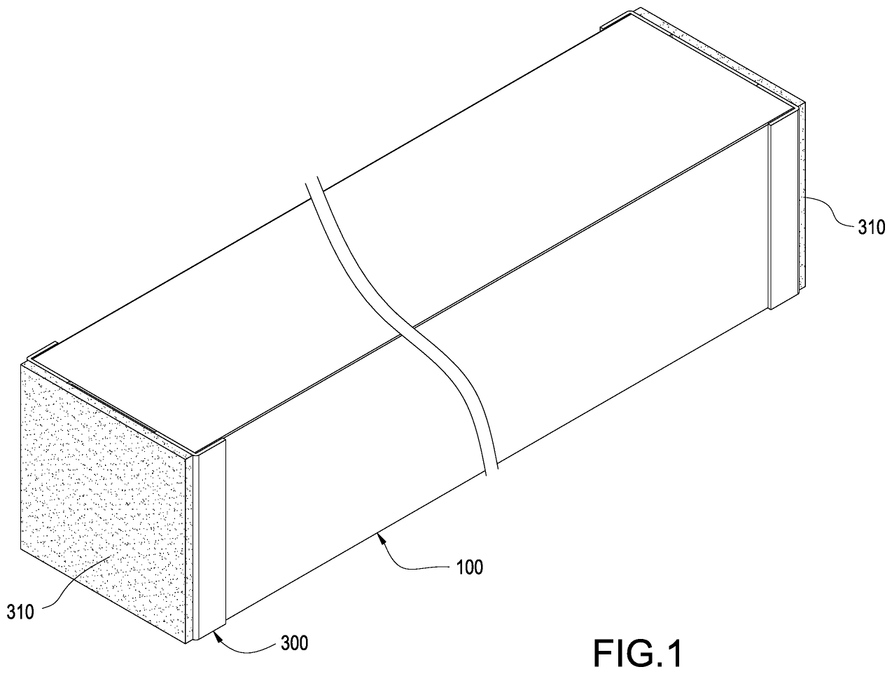

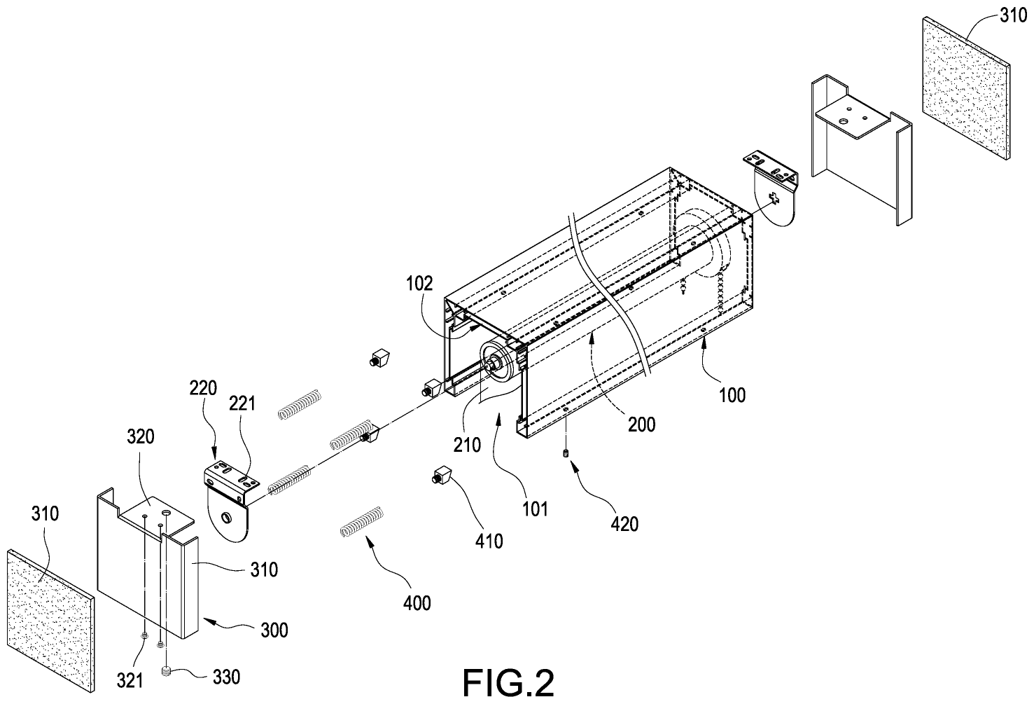

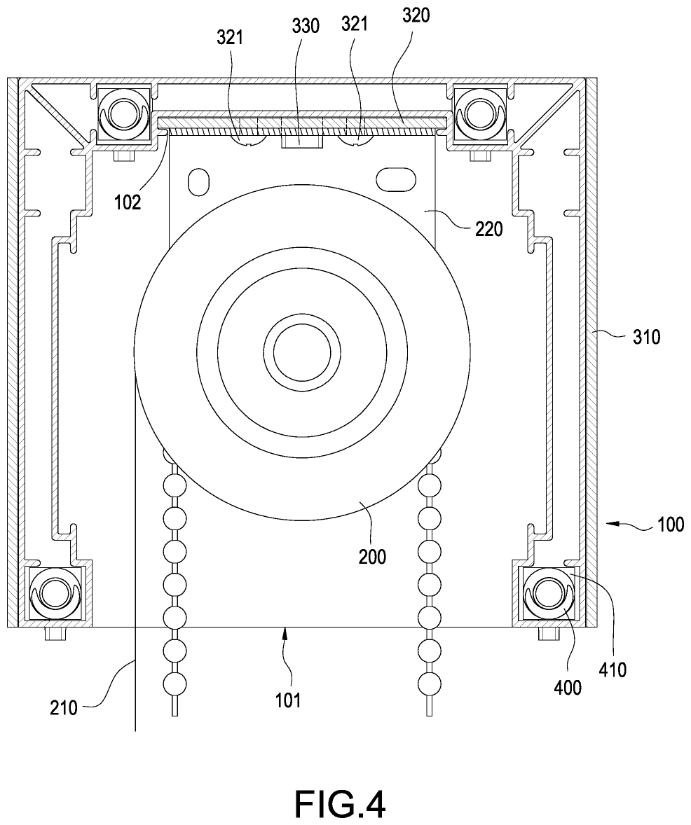

With reference to FIGS. 1 to 4 for a curtain carrier of one embodiment of this disclosure, the curtain carrier includes a frame 100, a hanging rod 200, a pressing block 300 and an elastic member 400.

In this embodiment, the frame 100 is of an elongated shape. Specifically, the frame 100 is a hollow column that is horizontally arranged and has a rectangular cross section. An opening 101 is formed on a side of the frame 100. In one embodiment, the opening 101 is arranged downwardly (defined on a bottom part of the frame 100). An inner side of one end of the frame 100 is provided with a guide rail 102, and the frame 100 has a stop pin 420 screwed to the frame 100 and penetrating through the frame 100.

The hanging rod 200 is accommodated in the frame 100 and provided for hanging a drape 210, and the drape 210 may pass through the opening 101 of the frame 100. Specifically, the hanging rod 200 is disposed pivotally to the frame 100 and may rotate by the axial direction of the hanging rod 200 as the axis of rotation, and the opening 101 is defined around the hanging rod 200. In one embodiment, the guide rail 102 in the frame 100 is extended in a direction parallel to the hanging rod 200, and the stop pin 420 is arranged perpendicularly to the hanging rod 200.

The pressing block 300 is installed on the frame 100, and the pressing block 300 is arranged corresponding to one end of the hanging rod 200, and the pressing block 300 may move along a longitudinal direction of the hanging rod 200. Specifically, the pressing block 300 has a sliding pin 320 plugged and connected to the guide rail 102, such that the pressing block 300 is installed to the aforementioned end of the frame 100. The sliding pin 320 may be movably plugged and connected to the guide rail 102 to guide the pressing block to move along the longitudinal direction of the hanging rod 200. In one embodiment, the sliding pin 320 includes a compression screw 330 penetrating through the sliding pin 320 and pressing the inner wall of the guide rail 102 to fix the position of the pressing block 300. An outer side of the pressing block 300 is provided with an elastic layer 310. The elastic layer is made of an elastically deformable material such as polyurethane, silicone, rubber, soft plastic, leather, etc.

In this embodiment, the hanging rod 200 includes a hanger 220 and the hanging rod 200 may be hung under the sliding pin 320 by the hanger 220. Specifically, the hanger 220 includes a sliding groove 221 extended in a direction parallel to the hanging rod 200, and the hanging rod 200 is pivoted to the hanger 220. A hook 321 is provided under the sliding pin 320 and passes through the sliding groove 221 to hang the hanger 220 under the sliding pin 320. In this embodiment, the hook 321 is a screw that is screwed to the sliding pin 320, passes through the sliding groove 221, and is arranged under the screw head to hook and connect an inner edge of the sliding groove 221.

The elastic member 400 is arranged on the frame 100. In this embodiment, the elastic member 400 is a cylindrical spring, but this disclosure is not limited to such arrangement only. The elastic member 400 is arranged parallelly to the hanging rod 200, and two ends of the elastic member 400 abut against the pressing block 300 and the stop pin 420 respectively. Therefore, when the pressing block 300 moves, the stop pin 420 may compress the elastic member 400.

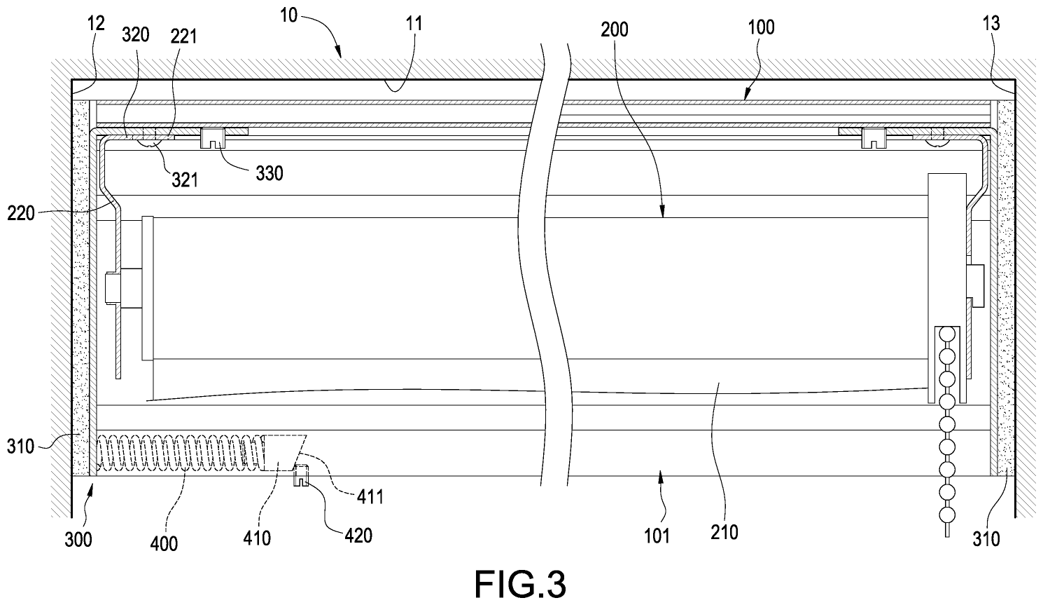

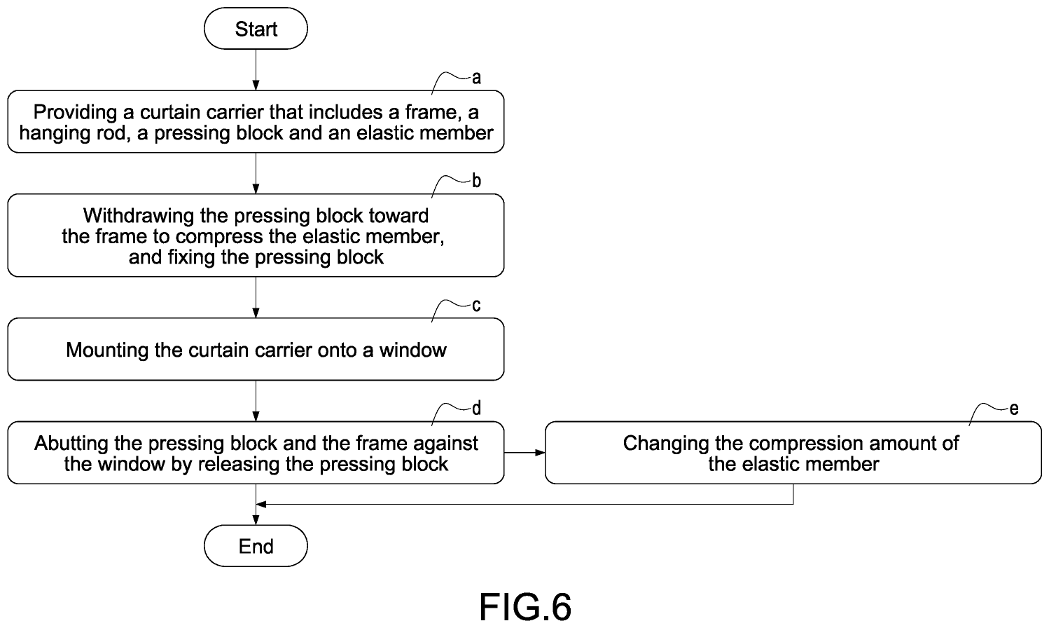

In FIGS. 3 and 6, the curtain carrier of this disclosure presses the elastic member 400 by the pressing block 300, so that the pressing block 300 is withdrawn toward the frame 100, while fixing the pressing block 300. After the pressing block 300 presses the elastic member 400, the pressing block 300 may be fixed manually, or the pressing block 300 may press the inner wall of the guide rail 102 through the compression screw 330 for fixation, and then the curtain carrier is mounted to a top edge 11 of a window 10, and the pressing block 300 and a side of the frame 100 opposite to the pressing block 300 face two side edges 12, 13 of the window 10 respectively, and then the user releases hand or the compression screw 330 is released to release the pressing block 300. After the pressing block 300 is released, the elastic member 400 is expanded to restore to its original position and push the pressing block 300 outward along the longitudinal direction of the hanging rod 200, and the elastic force of the elastic member 400 drives the pressing block 300 and the side of the frame 100 opposite to the pressing block 300 to abut against the two side edges 12, 13 on the left and right of the window 10 respectively. In this way, the curtain carrier may be installed easily and conveniently. The elastic layer 310 on the outer side of the pressing block 300 is in contact with the frame of the window, such that the curtain carrier and the side edge 12, 13 of the window 10 may be closed together with each other to increase friction, and the elastic layer 310 may be set on the frame 100 and the relative side of the pressing block 300.

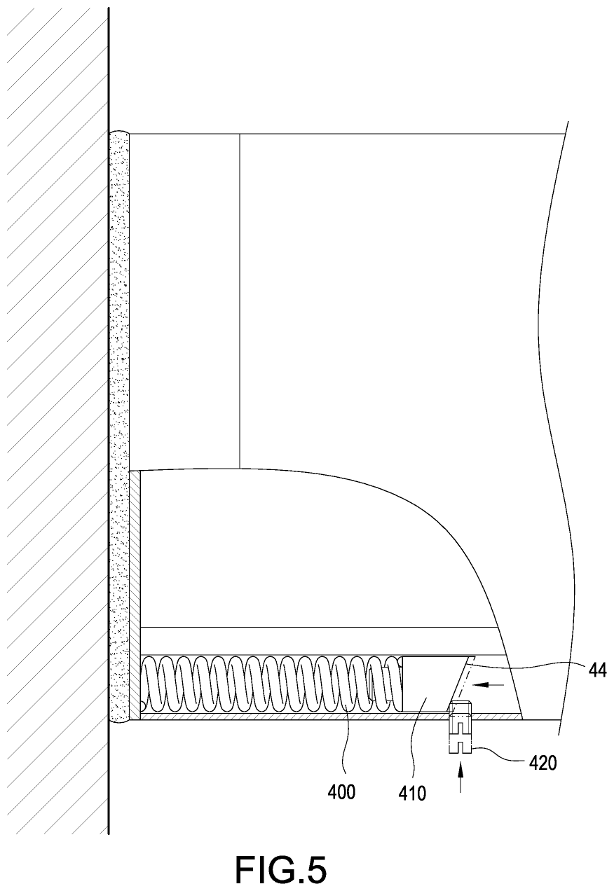

In this embodiment as shown in FIGS. 5 and 6, one end of the elastic member 400 is provided with a propping block 410, and the propping block 410 has a slope 411, and the stop pin 420 abuts against the slope 411. Therefore, twisting and turning the stop pin 420 to change the position of the stop pin 420 abutting against the slope 411 may change the position of the propping block 410 along the direction parallel to the hanging rod 200. In this way, the compression amount of the elastic member 400 is changed to adjust the force applied by the elastic member 400 to the pressing block 300.

The curtain carrier of this disclosure may change the overall length of the curtain carrier through the movable pressing block 300 to facilitate installing the curtain carrier in the window 10, and facilitate applying force to the pressing block 300 by the elastic member 400 for fixation. Therefore, the curtain carrier of this disclosure may be installed without the need of using any screw to be locked on the wall structure, thus achieve an easy installation. In addition, the hanging rod 200 and the drape 210 may be stored in the frame to avoid exposure.

While this disclosure has been described by means of specific embodiments, numerous modifications and variations could be made thereto by those skilled in the art without departing from the scope and spirit of this disclosure set forth in the claims.

What is claimed is:

1. A curtain carrier, comprising:
a frame (100), in an elongated shape;
a hanging rod (200), accommodated in the frame (100);
a pressing block (300), arranged on one end of the frame (100) corresponding to one end of the hanging rod (200), and movable along a longitudinal direction of the hanging rod (200); and
an elastic member (400), arranged on the frame (100) and compressible by the pressing block (300).

2. The curtain carrier according to claim 1, wherein the frame (100) comprises a stop pin (420), the elastic member (400) comprises a propping block (410), the propping block (410) comprises a slope (411), and the stop pin (420) abuts against the slope (411).

3. The curtain carrier according to claim 2, wherein the stop pin (420) is screwed to the frame (100) and perpendicular to the hanging rod (200).

4. The curtain carrier according to claim 1, wherein the hanging rod (200) is disposed pivotally on the frame (100) to be rotatable with respect to an axial direction of the hanging rod (200).

5. The curtain carrier according to claim 1, wherein the pressing block (300) comprises a sliding pin (320), the frame (100) comprises a guide rail (102) disposed on an inner side thereof, the guide rail (102) is extended parallelly to the hanging rod (200), and the sliding pin (320) is movably plugged to the guide rail (102) to guide the pressing block (300).

6. The curtain carrier according to claim 5, wherein the hanging rod (200) comprises a hanger (220), the hanger (220) comprises a sliding groove (221) extended parallelly to the hanging rod (200), the hanging rod (200) is connected pivotally to the hanger (220), and the sliding pin (320) comprises a hook (321) passing through the sliding groove (221) to make the hanger (220) be hung on the sliding pin (320).

7. The curtain carrier according to claim 6, wherein the sliding pin (320) comprises a compression screw (330) to fix the pressing block (300) by pressing an inner wall of the guide rail (102).

8. The curtain carrier according to claim 1, wherein the pressing block (300) comprises an elastic layer (310) attached to an outer side thereof, and the elastic layer (310) is made of a polyurethane material, a silicone material, or a rubber material.

9. An installing method of a curtain carrier, the installing method comprising:
a) providing the curtain carrier, wherein the curtain carrier comprises a frame (100), a hanging rod (200), a pressing block (300) and an elastic member (400), the hanging rod (200) is accommodated in the frame (100), the pressing block (300) is disposed on the frame (100) corresponding to one end of the hanging rod (200), the pressing block (300) is movable along a longitudinal direction of the hanging rod (200), and the elastic member (400) is arranged on the frame (100) and compressible by the pressing block (300);
b) withdrawing the pressing block (300) toward the frame (100) to compress the elastic member (400), and fixing the pressing block (300);
c) mounting the curtain carrier onto a window (10), and arranging the pressing block (300) and a side of the frame (100) opposite to the pressing block (300) to face two side edges (12, 13) of the window (10) respectively; and
d) releasing the pressing block (300) to restore the elastic member (400) to an original position, and abutting the pressing block (300) and the frame (100) against the two side edges (12, 13) of the window (10) respectively by an elastic force of the elastic member (400).

10. The installing method according to claim 9, wherein the frame (100) comprises a stop pin (420) screwed to the frame (100), the elastic member (400) comprises a propping block (410) disposed on an end thereof, the propping block (410) comprises a slope (411), and the stop pin (420) abuts against the slope (411);
and the installing method further comprises:
e) twisting the stop pin (420) to change a position of the stop pin (420) abutting against the slope (411) to change a position of the propping block (410) in a direction parallel to the hanging rod (200), and to further change a compression amount of the elastic member (400).
